(19) United States
(12) Patent Application Publication
(10) Pub. No.: US 2026/0303738 A1
(43) Pub. Date: Oct. 1, 2026

(54) INFORMATION PROCESSING APPARATUS, INFORMATION PROCESSING METHOD, AND NON-TRANSITORY RECORDING MEDIUM

(71) Applicant: Takuya MORI, Tokyo (JP)

(72) Inventor: Takuya MORI, Tokyo (JP)

(73) Assignee: Ricoh Company, Ltd., Tokyo (JP)

(21) Appl. No.: 19/568,190

(22) Filed: Mar. 16, 2026

(30) Foreign Application Priority Data
Mar. 31, 2025 (JP) 2025-059346

(51) Int. Cl. H04N 1/00

(52) U.S. Cl. CPC H04N 1/00748; H04N 1/00811; H04N 1/00824

(57) ABSTRACT

An information processing apparatus includes circuitry to detect an edge of a document in an image generated by scanning the document to obtain a first detection result of a document size of the document, record the first detection result of the document size, detect a document size of the document after recording the first detection result to obtain a second detection result of a document size of the document, and determine a document size of the document based on the first detection result and the second detection result of the document size.

### CROSS-REFERENCE TO RELATED APPLICATIONS

This patent application is based on and claims priority pursuant to 35 U.S.C. § 119 (a) to Japanese Patent Application No. 2025-059346, filed on Mar. 31, 2025, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

In an image forming apparatus that scans a document and generates an image file, an automatic detection technique for automatically detecting the document size of a document to be scanned has been developed. In order to cope with both a regular-size document and an irregular-size document without inputting a document size, a configuration is disclosed in which size information of an image is stored, and an object region including characters and graphics is extracted to determine a cutout region of the image.

### SUMMARY

The present disclosure described herein provides an information processing apparatus including circuitry to detect an edge of a document in an image generated by scanning the document to obtain a first detection result of a document size of the document, record the first detection result of the document size, detect a document size of the document after recording the first detection result to obtain a second detection result of a document size of the document, and determine a document size of the document based on the first detection result and the second detection result of the document size.

The present disclosure described herein provides an information processing method including detecting an edge of a document in an image generated by scanning the document to obtain a first detection result of a document size of the document, recording the first detection result of the document size, detecting a document size of the document after recording the first detection result to obtain a second detection result of a document size of the document, and determining a document size of the document based on the first detection result and the second detection result of the document size.

The present disclosure described herein provides a non-transitory recording medium storing a plurality of instructions which, when executed by one or more processors, causes the one or more processors to perform an information processing method including detecting an edge of a document in an image generated by scanning the document to obtain a first detection result of a document size of the document, recording the first detection result of the document size, detecting a document size of the document after recording the first detection result to obtain a second detection result of a document size of the document, and determining a document size of the document based on the first detection result and the second detection result of the document size.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing apparatus;

FIG. 2 is a diagram illustrating a functional configuration of an information processing apparatus;

FIG. 3 is a flowchart of a logic for determining a document size using a document-size determination-result recording table in an information processing apparatus;

FIG. 4 is a flowchart of a logic for assigning size classification numbers in an information processing apparatus;

FIG. 5 is a flowchart of a logic for displaying a document size close to the determined size to a user and allowing the user to select the document size, using a document-size determination-result recording table in an information processing apparatus; and

FIG. 6 is a diagram illustrating a screen image displayed on an operation panel in an information processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An embodiment of an image processing apparatus (or an information processing apparatus), an information processing method, and a non-transitory recording medium is described in detail below with reference to the accompanying drawings.

FIG. 1 is a diagram illustrating a configuration of the information processing apparatus. The information processing apparatus is an image processing apparatus or an image forming apparatus such as a multi-function peripheral (MFP) that scans a document to generate an image.

As illustrated in FIG. 1, the image forming apparatus includes a reading device 101, an image forming device 102, a nonvolatile storage area 103, a memory 104, an operation panel 105, a central processing unit (CPU) 106, and a communication device 107.

The reading device 101 is a device that reads a document such as paper, and includes an auto document feeder (ADF) and a document glass.

The image forming device 102 is a device (printer unit) that prints an image of a read document or an electronic image sent from, for example, a personal computer (PC) on a transfer sheet. When the information processing apparatus is not an image forming apparatus such as the MFP but a scanner alone, the image forming device 102 may not be included.

The nonvolatile storage area 103 stores programs such as an operating system (OS) of the MFP and application programs. The nonvolatile storage area 103 also stores, for example, setting values and operation histories of the image forming information processing apparatus.

The memory 104 is a memory that stores the OS and the application program. The memory 104 is also used to temporarily store read image data.

The operation panel 105 is used by the OS or the application programs to display data to the user or receive an instruction from the user.

The CPU 106 executes the OS and the application programs.

The communication device 107 is a network communication circuit that communicates using Ethernet®, Wi-Fi®, or a modem, and is used to communicate with other devices on a network.

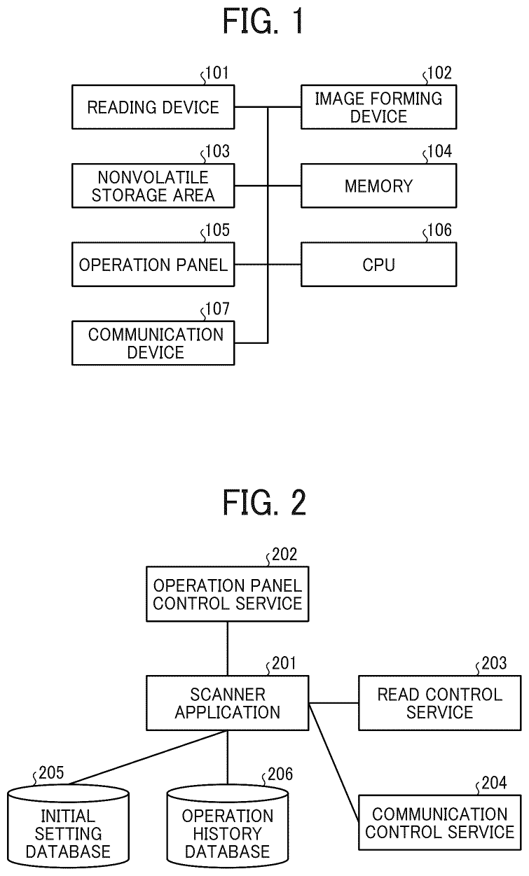

FIG. 2 is a diagram illustrating a functional configuration of the information processing apparatus. As illustrated in FIG. 2, the information processing apparatus includes, for example, a scanner application 201, an operation panel control service 202, a read control service 203, a communication control service 204, an initial setting database 205, and an operation history database 206.

The scanner application 201 implements a function of sending electronic data such as an email or a folder. In this disclosure, the scanner application 201 is described as a representative application for reading, but to the reading operation may be performed by a copy application and a fax application.

The operation panel control service 202 displays a user interface (UI) for allowing the user to use a transmission application on the screen of the operation panel 105 in response to an instruction from an application (transmission application) having a transmission function such as the scanner application 201. The operation panel control service 202 also sends a notification to the transmission application when the touch panel or the button is operated.

The read control service 203 operates the reading device 101 to read the document such as paper in accordance with an instruction from the transmission application such as the scanner application 201. The read control service 203 scans a document by the reading device 101 to generate an image. The read control service 203 is a detection unit that detects an edge of the document in the generated image to detect a document size (for example, an irregular document size).

As a method of detecting the document size, the edges of the document may be detected based on the feature amounts of a visible light image captured by the reading device 101 by irradiating the document with visible light and the feature amount of an invisible light image captured by the reading device 101 by irradiating the document with invisible light such as near-infrared light, and the document size may be detected based on the detection result of the edges. For the detection of the edge of the document, an edge detection method may be used based on the fact that there is a significant difference in the read value of the background between the visible light image and the invisible light image.

The read control service 203 also functions as a determination unit that determines, when a document size of the document is detected subsequently to recording of the detection result, a document size, which is a finally-determined document size, based on the document size that is subsequently detected and the detection result of the document size recorded in the operation history database 206. More specifically, the determination result of the document size, which is obtained by detecting the edges of the document having the irregular size, is recorded in the information processing apparatus each time, and then, the finally-determined document size can be determined based on the detection results of the document size recorded when the document size is determined by scanning. For example, in a case where the detection result of the document size is close to the recorded detection result, it is determined that the document size is the same between the detection result and the recorded detection result, and the average value of the detection result and the recorded detection result is taken to reduce the error, and the detection result of the closest document size can be presented to the user for selection. As a result, an error in determining the size of the document having the irregular size can be reduced.

For example, the read control service 203 may obtain the document sizes, each having a value within a predetermined error range from the detected document size, from the document size detection results recorded in the operation history database 206, and determine the finally-determined document size based on the average value of the obtained document sizes. By averaging the document sizes that are close to the detected document size, the errors can be converged to reduce the error in detection of the document size.

The read control service 203 may extract a document size close to the detected document size from the document size detection results recorded in the operation history database 206, generate a scanned image generated with both document sizes, display the scanned image on the screen, allow the user to select a document size, and determine the selected document size as the finally-detected document size. This enables the system to automatically classify similar document sizes and to allow the user to select a document size to be used, thereby eliminating an error.

The communication control service 204 controls a device such as a communication device 107 for performing network communication such as Ethernet® or Wi-Fi®.

The initial setting database 205 is a database for storing setting values for using the device.

The operation history database 206 is a database that records job conditions and document size determination results. In other words, the operation history database 206 is a recording unit that records the detection result of the document size by the read control service 203 in, for example, the image forming apparatus. The operation history database 206 stores a document-size determination-result recording table as illustrated in Table 1 below.

TABLE 1

| REC. | JOB EXEC. | JOB EXEG. | JOB | PAGE | DETERM. SIZE | DETERM. SIZE |
|---|---|---|---|---|---|---|
| NO. | DATE AND TIME | USER | NO. | NO. | WIDTH [mm] | LENGTH [mm] |
| 1 | Aug. 5, 2024 9:00 | Sato | 1 | 1 | 49 | 131 |
| 2 | Aug. 5, 2024 9:00 | Sato | 1 | 2 | 61 | 150 |
| 3 | Aug. 5, 2024 9:00 | Sato | 1 | 3 | 80 | 182 |
| 4 | Aug. 5, 2024 14:30 | Suzuki | 2 | 1 | 81 | 181 |
| 5 | Aug. 5, 2024 14:30 | Suzuki | 2 | 2 | 82 | 229 |
| 6 | Aug. 5, 2024 14:30 | Suzuki | 2 | 3 | 89 | 231 |
| 7 | Aug. 6, 2024 10:00 | Tanaka | 3 | 1 | 60 | 151 |
| 8 | Aug. 6, 2024 10:00 | Tanaka | 3 | 2 | 59 | 179 |
| 9 | Aug. 6, 2024 15:00 | Sato | 4 | 1 | 50 | 129 |
| 10 | Aug. 6, 2024 15:00 | Sato | 4 | 2 | 81 | 181 |

The document-size determination-result recording table illustrated in Table 1 is a table for recording the detection (determination) result of the document size when the document is scanned by the irregular document size automatic detection. The document-size determination-result recording table records the date and time when the scan job is executed, the user who executes the scan job, the number of the scan jobs, the page number, and the width (determination size width) and the length (determination size length) of the document size for each page in association with each other.

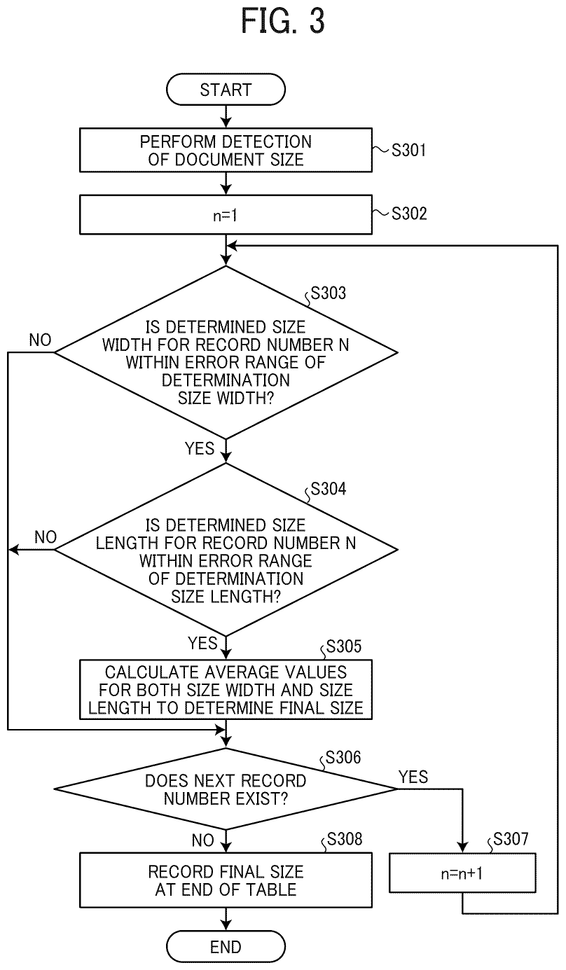

FIG. 3 is a flowchart of a logic for determining a document size using a document-size determination-result recording table in the information processing apparatus. In this example, the document size close to the document size detection result within the error range in the document-size determination-result recording table is searched for, and the average value thereof is taken to reduce the error of the document size.

In step S301, the detection of the document size is started. In step S302, the read control service 203 sets the record number n of the document size determination result record table to 1. In step S303, each time the read control service 203 scans and detects the document size, the read control service 203 refers to the determination size widths in order from the record number n of 1 in the document-size determination-result recording table, and determines the detection result of the document size and whether the document size is within the error range. In step S304, each time the read control service 203 scans and detects the document size, the read control service 203 refers to the determination size lengths in order from the record number n of 1 in the document-size determination-result recording table, and determines the detection result of the document size and whether the document size is within the error range.

The error range may be a default value allowed by the device registered in advance, or may be freely set by the user. In the following embodiments, the error range is set to 2 mm. In step S305, when both the widths and the lengths of the detected document sizes are within the error ranges, the read control service 203 regards the document sizes as the same document size, and calculates the mean value to determine a value with a reduced difference between the two sizes as the detected size. When there is a next record number n (Yes in step S306), in step S307, the read control service 203 increments the record number n, and returns to step S303. On the other hand, when there is no next record number n (No in step S306), in step S308, the read control service 203 records the determined detection size in the last record number n of the document-size determination-result recording table.

A specific example will be described using a document-size determination-result recording table illustrated in Table 1. It is assumed that the detection result of the document size is 59 mm in width and 149 mm in length. In the document-size determination-result recording table illustrated in Table 1, the recording numbers 2 and 7 are those in which both the determination size widths and the determination size lengths fall within the 2 mm of the error range. Therefore, when the read control service 203 averages the widths and lengths of the determination sizes of the recording numbers 2 and 7 and the detection result of the current document size according to the flowchart illustrated in FIG. 3, the width is (59+61+60)/3=60 mm and the length is (149+150+151)/3=150 mm. As a result, the read control service 203 records the document size determined this time as the width of 60 mm and the length of 150 mm in the last record number “11” of the document-size determination-result recording table, and generates an image of this size.

Table 2 below is a document-size determination-result recording table in which the size classification number is added to the document-size determination-result recording table of Table 1. The read control service 203 classifies document sizes regarded as the same document size within an error range among the detected document sizes and assigns numbers (size classification numbers) to the document sizes, thereby making it easy to handle similar document sizes. In the following figures, the manner of assigning size classification numbers and the embodiment of utilizing the size classification numbers are described. In other words, the detected document size may be classified into a document size within a predetermined error range among the recorded document size detection results and recorded as the document size in the operation history database 206. Thus, the system automatically classifies the similar document sizes, thereby handling only the document sizes with similar errors.

TABLE 2

| REC. | JOB EXEC. | JOB EXEC. | JOB | PAGE | DETERM. SIZE | DETERM, SIZE | SIZE |
|---|---|---|---|---|---|---|---|
| NO. | DATE AND TIME | USER | NO. | NO. | WIDTH Imnd) | LENGTH [mm] | GLAS. NO. |
| 1 | Aug. 5, 2024 9:00 | Sato | 1 | 1 | 51 | 61 | 1 |
| 2 | Aug. 5, 2024 9:00 | Sato | 1 | 2 | 61 | 150 | 2 |
| 3 | Aug. 5, 2024 9:00 | Sato | 1 | 3 | 80 | 182 | 3 |
| 4 | Aug. 5, 2024 14:30 | Suzuki | 2 | 1 | 81 | 181 | 3 |
| 5 | Aug. 5, 2024 14:30 | Suzuki | 2 | 2 | 82 | 229 | 4 |
| 6 | Aug. 5, 2024 14:30 | Suzuki | 2 | 3 | 89 | 231 | 5 |
| 7 | Aug. 6, 2024 10:00 | Tanaka | 3 | 1 | 60 | 151 | 2 |
| 8 | Aug. 6, 2024 10:00 | Tanaka | 3 | 2 | 59 | 179 | 6 |
| 9 | Aug. 6, 2024 15:00 | Sato | 4 | 1 | 50 | 60 | 1 |
| 10 | Aug. 6, 2024 15:00 | Sato | 4 | 2 | 81 | 181 | 3 |

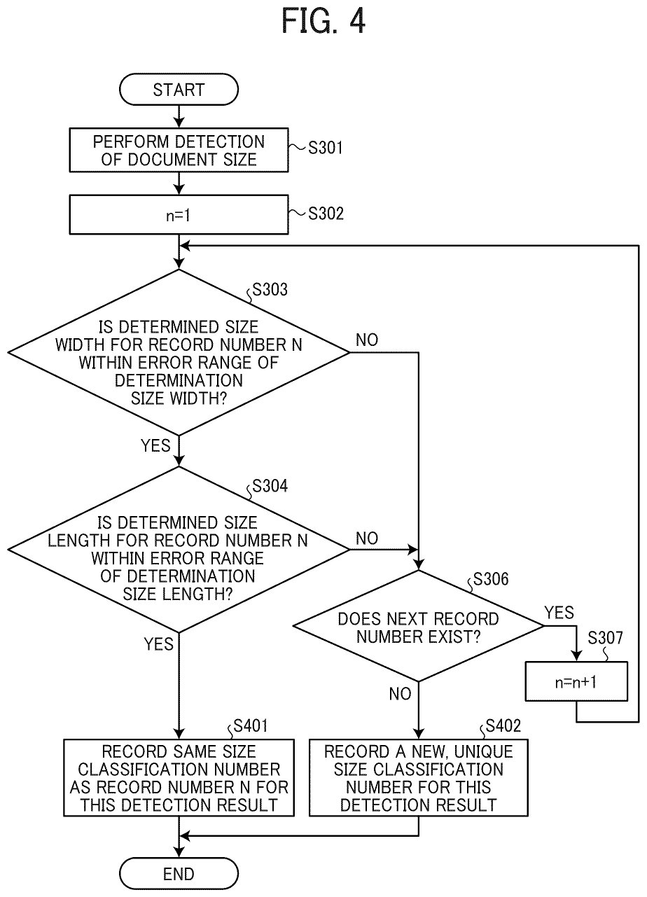

FIG. 4 is a flowchart of a logic for assigning size classification numbers in the information processing apparatus. In step S401, similar to FIG. 3, the read control service 203 determines whether the detection result of the document size is within the error range from the document size in the document-size determination-result recording table. When the detection result is within the error range, the read control service 203 regards the document size as the same document size and assigns the same size class number. When there is no document size that falls within the error range, In step S402, the read control service 203 assigns a new size class number that does not overlap with other size class numbers.

A specific example will be described using the document-size determination-result recording table illustrated in Table 2. The read control service 203 detects the document size, and when the detected document size has the width of 90 mm and the length of 230 mm, the document size whose length and width are both within the error range of 2 mm in the document-size determination-result recording table illustrated in Table 2 is the document size with the recording number 6. In this case, the size class number is regarded as the same as the record number 6, and the size class number 5 is recorded in the last record number 11 of the table for the width of 90 mm and the length of 230 mm.

As another pattern, when the document size is detected and the detected document size has the width of 70 mm and the length of 140 mm, there is no record number in which the widths and lengths are within the error range of 2 mm in the document size determination result record table illustrated in Table 2. In this case, since there is no same size category number, the size category number is recorded as a new size category number 7 in the last record number 12 of the document size determination result record table.

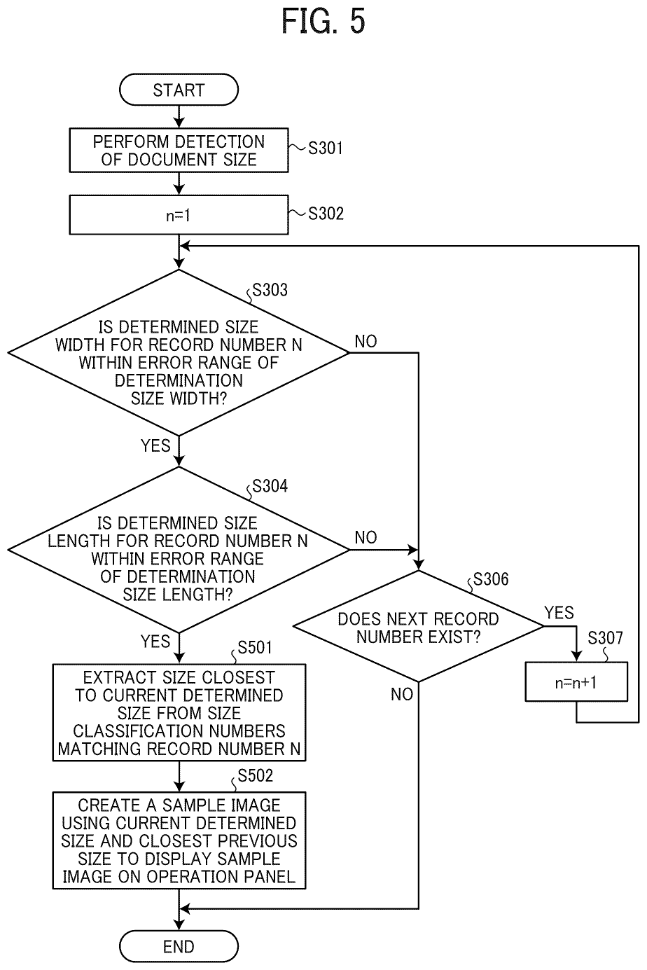

FIG. 5 is a flowchart of a logic for displaying a document size close to the determined size to the user and allowing the user to select the document size, using the document-size determination-result recording table in the information processing apparatus. In step S501, similar to FIG. 3, the read control service 203 determines whether the detection result of the document size is within the error range with the document size in the document-size determination-result recording table. When the detection result is within the error range, the read control service 203 extracts the document size having the smallest error and being close to the same size class number as a representative. The read control service 203 generates a scanned image with the current document size and the extracted document size (representative size), displays the scanned image as a size candidate on the operation panel (step S502), and allows the user to select a document size to be actually used, thereby allowing the user to determine the size as a more desired size.

For example, it is assumed that the document size is detected as the width of 48 mm and the length of 58 mm. In the document-size determination-result recording table illustrated in Table 2, the read control service 203 determines that the recording number 9 and the size class number 1 are included in the error range of 2 mm for both the widths and the lengths. The same size class number 1 also applies to the record number 1, but the values of the record number 9 are 48 mm in width and 58 mm in length, which are closest to 50 mm in width and 60 mm in length, and therefore the record number 9 is extracted and displayed as the size closest to the operation panel.

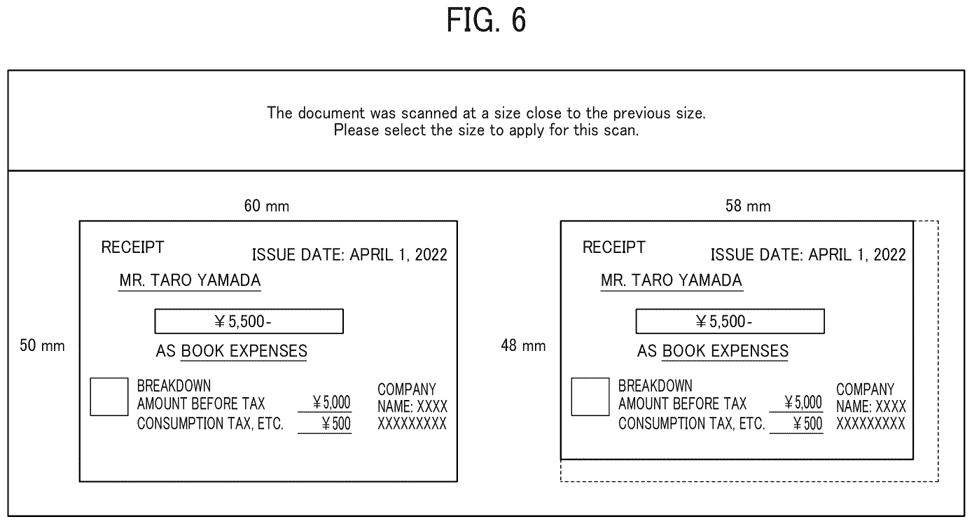

FIG. 6 is a diagram illustrating a screen image displayed on the operation panel 105 in the information processing apparatus. The read control service 203 generates a preview of the scanned image with the document size closest to the document size detection result in the document-size determination-result recording table, and displays the document size and the scanned image on the screen. The user can compare the numerical value of the document size with the scanned image and select a document size that the user actually wants to use. In the example illustrated in FIG. 5, the document size detection results of 48 mm in width and 58 mm in length are displayed, and the document size and the scanned image are displayed as illustrated in FIG. 6, because the width of 50 mm and the length of 60 mm are displayed as the closest document sizes.

In the present embodiment, the read control service 203 may cause, for example, the image processing apparatus to accumulate (accumulate in the operation history database 206 illustrated in FIG. 2) the feature amount of the image read by the reading device 101 and the document size selected by the user. The read control service 203 may construct a document size determination model using the accumulated data as teacher data, store the model in an apparatus such as an image processing apparatus, and detect the document size using the determination model.

The feature amount of the image includes, for example, a color distribution of the image or character information obtained by character recognition. When the document is a document such as the receipt illustrated in FIG. 6, the ratio of the white portion which is the base color of the document is high, the ratio of the black portion of the character portion is small, and the distribution of other colors, particularly, the intermediate color is further small. On the other hand, in the case of an image such as a photograph, the distribution of white is small and the distribution of intermediate colors is relatively large compared to the above-described receipt. In the case of a photograph, the character information that can be recognized in the image is relatively small. The color distribution, the amount of character information, and the document size selected by the user can be accumulated to be used as the above-described teacher data. Thus, the accuracy of determination by the document size determination model can be enhanced.

As described above, according to the information processing apparatus, the determination result of the document size by the edge detection of the document of the irregular size is recorded in the information processing apparatus each time, and thereafter, the final document size can be determined from the detection result of the document size recorded when the document size is determined by scanning. As a result, an error in the size determination of the document of the irregular size can be reduced.

The process of determining the document size is implemented in the image processing apparatus such as an MFP, but the image processing apparatus is not limited to the MFP. The process of determining the document size may be implemented in an information processing apparatus such as a personal computer (PC) connectable to a scanner and a printer (at least the scanner).

Note that the computer programs performed in the information processing apparatus according to the above-described embodiments may be preliminarily installed in a memory such as a read-only memory (ROM). The program executed by the information processing apparatus according to the present embodiment may be stored in any computer-readable recording medium, such as a compact disc-read-only memory (CD-ROM), a flexible disk (FD), a compact disc-recordable (CD-R), or a digital versatile disc (DVD), in an installable or executable file format and provided as a computer program product.

Alternatively, the computer programs executed in the information processing apparatus according the above-described embodiments can be stored in a computer connected to a network such as the Internet and downloaded through the network. Alternatively, the computer programs executed in the information processing apparatus according to the above-described embodiment can be provided or distributed via a network such as the Internet.

The program executed by the information processing apparatus is in a modular configuration including the above-described units (e.g., the scanner application 201, the operation panel control service 202, the read control service 203, and the communication control service 204). As hardware, as the CPU 106 reads the program from the above-mentioned ROM and executes the program, the above-described functional units are loaded and implemented (generated) in a main memory.

An example was given in which the image forming apparatus is applied to the MFP having at least two of copying, printing, scanning, and facsimile functions. Alternatively, the image forming apparatus may be applied to any image forming device such as for example, a copier, a printer, a scanner, or a facsimile machine.

Aspects of the present disclosure are, for example, as follows.

### Aspect 1

An information processing apparatus includes a detection unit that detects an edge of a document in an image generated by scanning the document to detect a document size, a recording unit that records a detection result of the document size by the detection unit, and a determination unit that determines, when the document size is detected later, a final document size based on the document size detected later and the recorded detection result of the document size.

### Aspect 2

In the information processing apparatus according to Aspect 1, the determination unit detects the document size within a predetermined error range from the recorded detection result of the document size with respect to the detected document size, and determines the final document size based on an average value of the document size.

### Aspect 3

In the information processing apparatus according to Aspect 1 or 2, the recording unit classifies and records the document size within a predetermined error range among the recorded detection results of the document size with respect to the detected document size.

### Aspect 4

In the information processing apparatus according to any one of Aspects 1 to 3, the determination unit extracts the document size close to the detected document size among the recorded detection results of the document size, generates a scanned image created with both the document sizes, displays the scanned image on a screen, receives a user selection relating to the document size, and determines the selected document size as the final document size.

### Aspect 5

An information processing method executed by an information processing apparatus, the information processing method includes detecting an edge of a document in an image generated by scanning the document to detect a document size, recording a detection result of the document size by the detection unit, and determining, when the document size is detected later, a final document size based on the document size detected later and the recorded detection result of the document size.

### Aspect 6

A program causes a computer to function as a detection unit that detects an edge of a document in an image generated by scanning the document to detect a document size, a recording unit that records a detection result of the document size by the detection unit, and a determination unit that determines, when the document size is detected later, a final document size based on the document size detected later and the recorded detection result of the document size.

In the related art, it is difficult to register all sizes of documents of irregular sizes in the apparatus in advance, and the document size is detected and determined every time scanning is performed, so that an error may occur. In addition, a surrounding extraction region is determined at a predetermined interval with respect to an object region such as a character and a figure, but in a case of a document in which a margin is not at a constant interval with respect to an object, a range different from an original document is extracted.

According to one aspect of the present disclosure, errors in determining the sizes of irregularly shaped originals are reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising circuitry configured to:
detect an edge of a document in an image generated by scanning the document to obtain a first detection result of a document size of the document;
record the first detection result of the document size;
detect a document size of the document after recording the first detection result to obtain a second detection result of a document size of the document; and
determine a document size of the document based on the first detection result and the second detection result of the document size.

2. The information processing apparatus according to claim 1,
wherein the circuitry is configured to obtain one or more document sizes each being within a predetermined error range from the detected document size of the second detection result, from the first detection result of the document size, and determines the document size based on an average value of the obtained document sizes.

3. The information processing apparatus according to claim 1,
wherein the circuitry is configured to classify and record one or more document sizes each being within a predetermined error range from the detected document size of the second detection result and obtained from the second detection result.

4. The information processing apparatus according to claim 1,
wherein the circuitry is configured to extract a document size having a value close to the detected document size of the second detection result from the second detection result, generate scanned images respectively created with the detected document size of the second detection result and the extracted document size, display the scanned images on a screen, receive a user selection for the document size, and determine the selected document size as the document size.

5. An information processing method comprising:
detecting an edge of a document in an image generated by scanning the document to obtain a first detection result of a document size of the document;
recording the first detection result of the document size;
detecting a document size of the document after recording the first detection result to obtain a second detection result of a document size of the document; and
determining a document size of the document based on the first detection result and the second detection result of the document size.

6. A non-transitory recording medium storing a plurality of instructions which, when executed by one or more processors, causes the one or more processors to perform an information processing method comprising:
detecting an edge of a document in an image generated by scanning the document to obtain a first detection result of a document size of the document;
recording the first detection result of the document size;
detecting a document size of the document after recording the first detection result to obtain a second detection result of a document size of the document; and
determining a document size of the document based on the first detection result and the second detection result of the document size.
